(19) United States
(12) Patent Application Publication
(10) Pub. No.: US 2014/0293607 A1
(43) Pub. Date: Oct. 2, 2014

(54) LENS MODULE AND LED LIGHTING MODULE HAVING THE SAME

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 14/056,968

(22) Filed: Oct. 18, 2013

(30) Foreign Application Priority Data
Mar. 27, 2013 (TW) 102110784

(51) Int. Cl. F21V 5/00

(52) U.S. Cl. CPC F21V 5/008
USPC 362/268; 362/331

(57) ABSTRACT

A lens module for divergently refracting light from an LED includes a first lens and a second lens matching with the first lens. The first lens is received in the second lens, and the first lens is spaced from the second lens. The LED is received in the first lens. A central axis of the first lens coincides with a central axis of the second lens. Light emitted from the LED and into the lens module is refracted out by the first lens and the second lens. The first and second lenses have different capabilities of refraction. This disclosure also relates an LED lighting module with the lens module.

### BACKGROUND

1. Technical Field

The disclosure generally relates to light sources, and particularly, to a lens module with a first lens and a second lens receiving the first lens therein, and an LED lighting module having the lens module.

2. Description of Related Art

A conventional light emitting diode (LED) package includes a substrate, a first electrode and a second electrode arranged on a top surface of the substrate, at least one light emitting diode mounted on the substrate and electrically connecting with the first and second electrodes respectively.

However, each LED package generates a smooth round light field, and the light emitted from the LED package is mainly concentrated at a center thereof. The light at a periphery of the LED package is relatively poor to illuminate. Therefore, the light emitted from the LED packages can not be uniformly emitted out. When this happens, the performance of the LED package will be unfavorably affected, particularly when the LED package is used as a light source for a planar illumination such a backlight module for an LCD (liquid crystal display).

What is needed, therefore, is a lens module and an LED lighting module having the lens module which can overcome the described-above shortcomings.

### BRIEF DESCRIPTION OF THE DRAWINGS

FIG. 1 is a cross-sectional view of an LED lighting module in accordance with an exemplary embodiment of the present disclosure, taken along a line cutting through a central axis of the LED lighting module.

FIG. 2 is essentially an exploded, perspective view of a lens module of the LED lighting module of FIG. 1.

FIG. 3 is an inverted view of the lens module of FIG. 2.

FIG. 4 shows light paths of a light emitting diode (LED) of the LED lighting module of FIG. 1 through the lens module thereof.

### DETAILED DESCRIPTION

An exemplary embodiment of an LED (light emitting diode) lighting module 1 in accordance with the present disclosure will now be described in detail below and with reference to the drawings.

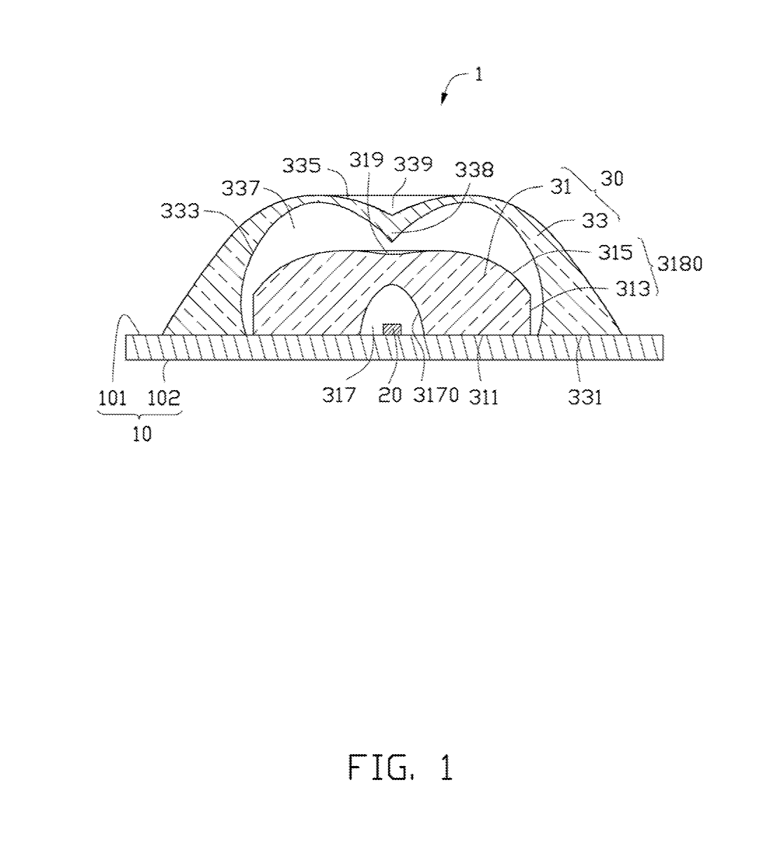

Referring to FIG. 1, the LED lighting module 1 includes a substrate 10, an LED 20 mounted on the substrate 10, and a lens module 30 located on the substrate 10 and covering the LED 20 therein. The LED light module 1 is mainly used as a light source for a backlight module for a planar display such as a liquid crystal display (LCD). The LED 20 may include an LED chip and an encapsulation enclosing the LED chip therein, wherein the encapsulation may include fluorescent particles distributed therein for converting color (for example, blue) of light from the LED chip to a desired color (for example, white).

The substrate 10 is a flat plate, and is made of electrically insulating materials, such as ceramics, Si (silicon), sapphire, or SiC (silicon carbide).

The substrate 10 includes a top surface 101 and a bottom surface 102 opposite and parallel to the top surface 101. A circuit (not shown) is arranged on the top surface 101 of the substrate 10. In this embodiment, the LED 20 is located on the top surface of the substrate 10, and electrically connects with the circuit on the top surface 101 of the substrate 10. The lens module 30 is mounted on the top surface 101 of the substrate 10 and covers the LED 20, whereby light field of light from the LED 20 is adjusted by the lens module 30 to a desired pattern when the light is emitted from the LED lighting module 1.

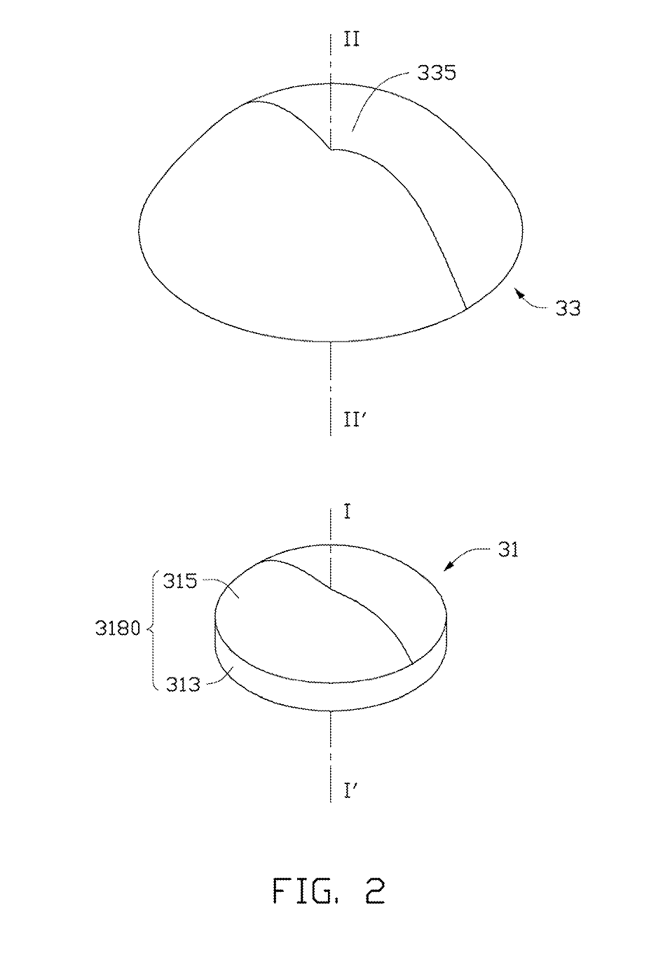

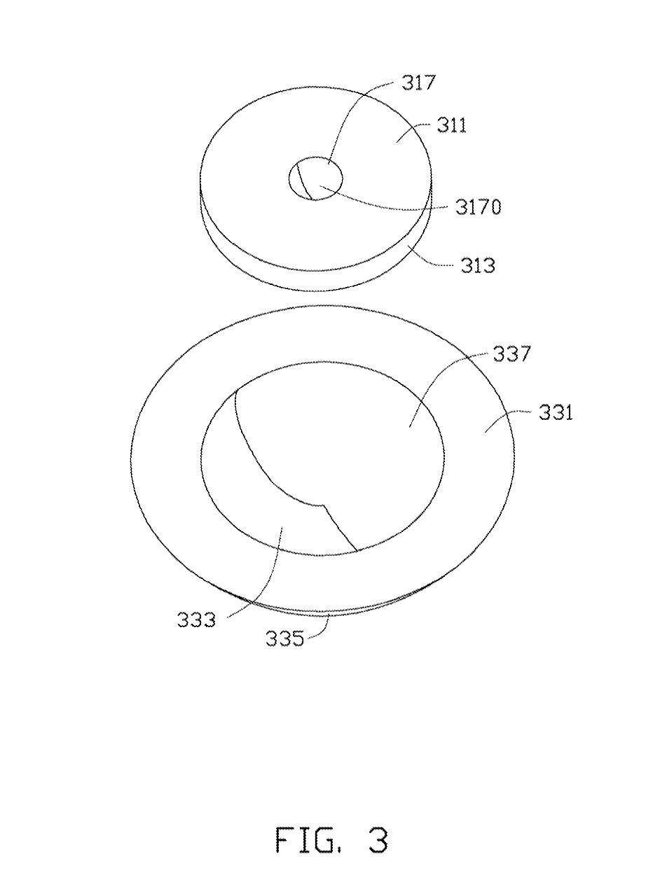

Referring to FIGS. 1-3, the lens module 30 includes a first lens 31 and a second lens 33 enclosing and matching with the first lens 31. A size of the first lens 31 is less than a size of the second lens 33, and the first lens 31 is received in the second lens 33.

The first lens 31 is generally cylindrical in profile, and covers the LED 20 therein. The first lens 31 is centrosymmetric about a central axis I-I′ thereof The lens 30 is made of transparent materials with a good optical performance, such as PMMA (polymethyl methacrylate) or PC (polycarbonate) plastic.

The first lens 31 includes a flat bottom surface 311, an annular side surface 313 extending upwardly from the bottom 311, and a curved top surface 315 extending upwardly from a top of the annular side surface 313.

The annular side surface 313 upwardly extends from a peripheral edge of the bottom surface 311. The top surface 315 extends upwardly and radially inward from the top of the annular side surface 313 to a highest point, and then extends gently downwardly and radially inward from the highest point toward the center of the first lens 31 through which the central axis I-I′ extends.

In this embodiment, the top surface 315 is recessed to and concentered at a point on the central axis I-I′. Such that, a first recess 319 is defined in a central portion of the top surface 315. The first recess 319 is recessed downwardly along the central axis I-I′. The first recess 319 is funnel shaped. Light emitted into the first recess 319 is divergently refracted toward peripheral sides of the central axis I-I′ of the first lens 31.

A recess 317 is recessed from an inner periphery of the bottom surface 311 of the first lens 31. The recess 317 is recessed upwardly along a direction away from the substrate 10. The recess 317 is used to receive the LED 20 therein.

An inner surface of the recess 317 functions as a first light incident surface 3170 of the first lens 31. Light emitted from the LED 20 is divergently refracted by the first light incident surface 3170 into an inside of the first lens 31. In this embodiment, the inner surface of the recess 317 is arc-shaped, and is recessed upwardly along a direction away from the substrate 10. More specifically, the first light incident surface 3170 is a part of an ellipsoid and a major axis of the ellipsoid constructing the first light incident surface 3170 is collinear with the central axis I-I′ of the first lens 31.

The annular side surface 313 and the top surface 315 of the first lens 31 corporately function as a first light output surface 3180 of the first lens 31. A curvature of the top surface 315 of the first light output surface 3180 is less than a curvature of the first light incident surface 3170 while the annular side surface 313 is a vertical plane, such that light emitted from the LED 20 is divergently refracted by the first light incident surface 3170 and the first light output surface 3180 in different degrees.

The second lens 32 is generally inverted bow-shaped, and is centrosymmetric about a central axis II-IF of the second lens 32. The second lens 32 is made of transparent materials with a good optical performance, such as PMMA (polymethyl methacrylate) or PC (polycarbonate) plastic.

The second lens 33 includes a flat bottom surface 331, an inner surface 333 extending upwardly from an inner periphery of the bottom surface 331, and an outer surface 335 extending from an outer periphery of the bottom surface 331. In this embodiment, an outer diameter of the second lens 33 gradually decreases along the central axis II-IF from the bottom surface 331 toward the top of the second lens 33.

The inner surface 333 extends upwardly along a direction away from the substrate 10, such that, a receiving space 337 is defined in the second lens 33. A size of the receiving space 337 is larger than the size of the first lens 31. The first lens 31 is received in the receiving space 337, and the annular side surface 313 and the top surface 315 of the first lens 31 are spaced from the inner surface 333 of the second lens 33.

The receiving space 337 is centrosymmetric about the central axis II-II′, and a cross-section through the central axis II-IF of the second lens 33 has a substantially “M” shaped configuration, whereby the receiving space 337 has a corresponding M-shaped profile. The inner surface 333 of the second lens 33 extends upwardly and curvedly along a direction away from the substrate 10 to a highest point, and then extends downwardly and radially inward from the highest point towards the central axis II-II′. From the bottom to the highest point of the inner surface 333, the inner surface 333 is so curved that it forms a recess facing the LED 20. In this embodiment, the inner surface 333 of the second lens 33 is extended downwardly and inwardly from the highest point thereof to be concentered to a point on the central axis II-II′, and the center of the inner surface 333 is a sharp tip 338 pointing to the center of the first recess 319.

The inner surface 333 functions as a second light incident surface of the second lens 33. The curvature of the second light incident surface 333 is larger than the curvature of the first light output surface 3180.

The outer surface 335 functions as a second light output surface of the second lens 33. The curvature of the second light output surface is less than the second incident surface, such that light emitting through the second light incident surface and the second light output surface is divergently refracted in different degrees.

Furthermore, a thickness (as measured along a radius of the second lens 33) of the second lens 33 gradually decreases along a direction from the bottom surface 331 to a minimum thickness at a highest point of the second lens 33, and then gradually increases from the highest point of the second lens 33 to a center of the second lens 33 which is located corresponding to the tip 338 of the second lens 33.

The outer surface 335 extends upwardly and radially inward along a direction from the outer periphery of the bottom surface 331 to a highest point of the outer surface 335, and then extends downwardly and radially inward from the highest point thereof toward a point on the central axis II-II′. In this embodiment, a second cavity 339 is defined in a central portion of the outer surface 335. The second cavity 339 is funnel shaped, and light emitted into the second cavity 339 is divergently refracted by the outer surface 335 defining the second cavity 339 towards peripheral sides of the central axis II-II′.

Referring to FIG. 1, when the LED lighting module 1 is assembled, the LED 20 is located in a center of the recess 317 of the first lens 31. The first lens 31 is received in the receiving space 337 of the second lens 33, and is spaced from the second lens 33. The central axis I-I′ of the first lens 31 coincides with the central axis II-IF of the second lens 33. In this embodiment, the LED 20, the first lens 31 and the second lens 33 are aligned with each other; that is, centers of the LED 20, the first and second lens 31, 33 are on a same straight line.

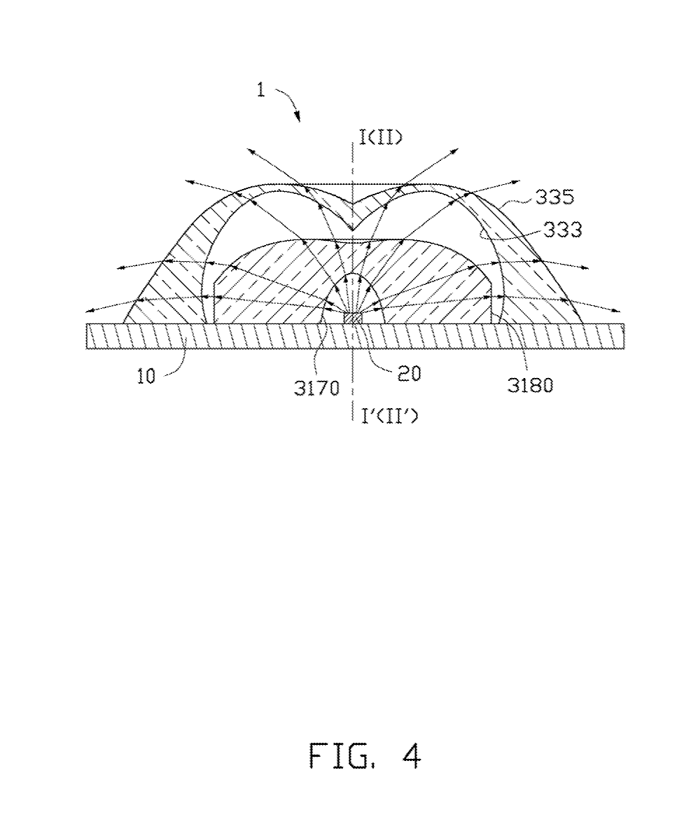

Referring to FIG. 4, when the LED lighting module 1 works, light emitted from the LED 20 is refracted by the first incident surface 3170 into the inside of the first lens 31, and the light emits out of the first lens 31 from the first light output surface 3180 toward the second lens 33.

And then, the light radiates into the second lens 33 from the inner surface 333 and radiates out from the outer surface 335 of the second lens 33.

According to the LED lighting module 1 of the present disclosure, because the light emitted from LED 20 is sequentially refracted by the first light incident surface 3170, the first light output surface 3180, the inner surface 333 and the outer surface 335 of the second lens 33, which makes the LED lighting module 1 have a wider range of illumination. Besides, because the curvature of the first light incident surface 3170 is larger than the curvature of the top surface 315 of the first light output surface 3180, the curvature of the inner surface 333 of the second lens 33 is larger than the curvature of the top surface 315 of the first light output surface 3180, and the curvature of the outer surface 335 of the second lens 33 is less than the curvature of the inner surface 333 of the second lens 33, when the light sequentially emits through the first light incident surface 3170, the first light output surface 3180, the inner surface 333 and the outer surface 335 of the second lens 33, the light is divergently refracted in different degrees, which makes the light from the LED lighting module 1 more uniformly.

Furthermore, because a central light with a high light intensity of the LED 20 is sequentially refracted by the top surface 315 defining the first cavity 319 and the outer surface 335 defining the second cavity 339 to peripheral sides of the central axes of the first and second lens 31, 33, the light emitted from the LED lighting module 1 becomes more uniformly distributed. Accordingly the LED lighting module 1 can be used as a light source for a planar illumination device.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A lens module for an LED (light emitting diode)to divergently refract light from the LED, comprising:
a first lens configured for receiving the LED therein; and
a second lens matching with the first lens;
wherein the first lens is received in the second lens, and the first lens and the second lens are spaced from each other, a central axis of the first lens coincides with a central axis of the second lens, and light from the LED and emitting through the lens module is sequentially and divergently refracted out by the first and second lens having different refracting capabilities.

2. The lens module of claim 1, wherein the second lens comprises a light incident surface and a light output surface, and a curvature of the light incident surface of the second lens is larger than a curvature of the light output surface of the second lens.

3. The lens module of claim 2, wherein the first lens comprises a light incident surface and a light output surface, the light incident surface of the first lens faces toward the light incident surface of the second lens, and a curvature of the light incident surface of the first lens is larger than a curvature of a top portion of the light output surface of the first lens.

4. The lens module of claim 3, wherein the curvature of the light incident surface of the second lens is larger than the curvature of the top portion of the light output surface of the first lens.

5. The lens module of claim 1, wherein the second lens comprises a flat bottom surface, an inner surface extending upwardly from an inner periphery of the bottom surface, and an outer surface extending upwardly and radially inward toward the central axis of the second lens, the inner surface is the light incident surface of the second lens, and the outer surface is the light output surface of the second lens.

6. The lens module of claim 5, wherein the inner surface extends curvedly and upwardly from the flat bottom surface along the central axis of the second lens to a highest point, and then extends from the highest point thereof downwardly and radially inward toward the axis of the second lens, and wherein from the bottom surface to the highest point of the inner surface, the inner surface is so curved that it forms a recess facing the central axis of the second lens.

7. The lens module of claim 6, wherein the inner surface is extended from the highest point thereof downwardly and inwardly to be concertered at a point on the central axis of the second lens, and a center of the inner surface is a sharp tip.

8. The lens module of claim 5, wherein the outer surface extends upwardly and radially inward to a highest point thereof, and then extends from the highest point thereof downwardly and radially inward toward the central axis of the second lens.

9. The lens module of claim 8, wherein the outer surface is extended downwardly and inwardly from the highest point thereof to be concentered at a point on the central axis of the second lens, and a cavity is defined in a central portion of the outer surface.

10. The lens module of claim 9, wherein the cavity is funnel shaped.

11. The lens module of claim 5, wherein the second lens is inverted bow-shaped, and an outer diameter of the second lens gradually decreases along a direction from the bottom surface to the top of the second lens.

12. The lens module of claim 5, wherein a receiving space is defined by the inner surface of the second lens, the first lens is received in the recess.

13. The lens module of claim 12, wherein a cross section of the receiving space through the central axis of the second lens has a substantially “M” shaped configuration.

14. The lens module of claim 13, wherein the first lens comprises a flat bottom surface, an annular side surface extending upwardly from the bottom surface, and a curved surface extending upwardly from a top of the side surface, the annular side surface and the top surface are spaced from the inner surface of the receiving space of the second lens.

15. The lens module of claim 14, wherein a recess is recessed upwardly from the bottom surface of the first lens, configured for receiving the LED therein, an inner surface of the recess is the light incident surface of the first lens, and the annular side surface and the top surface of the first lens are the light output surface of the first lens.

16. The lens module of claim 14, wherein the top surface of the first lens extends upwardly and radially inward to a highest point thereof, and then extends from the highest point thereof downwardly and radially inward toward the central axis of the first lens.

17. The lens module of claim 16, wherein the top surface of the first lens is extended downwardly and inwardly to be concentered at a point on the central axis of the first lens, and a cavity is defined in the central portion of the top surface.

18. The lens module of claim 17, wherein the cavity in the central portion of the top surface of the first lens is funnel shaped.

19. An LED lighting module, comprising:
a substrate;
an LED mounted on the substrate and electrically connecting with the substrate; and
a lens module located on the substrate and covering the LED therein;
wherein the lens module comprises a first lens and a second lens matching with the first lens, the first lens is received in the second lens, the LED is received in the first lens and the first lens and the second lens are spaced from each other, a central axis of the first lens coincides with a central axis of the second lens, and light emitted from the LED emits through the lens module is sequentially refracted by the first and second lens to emit out divergently and uniformly.

20. The light module of claim 19, wherein the first lens comprises a flat bottom surface, an annular side surface extending from the bottom surface and a curved surface extending upwardly from a top of the annular side surface, a recess is upwardly recessed from the bottom surface of the first lens, the LED is located at a center of the recess, the second lens comprises a flat bottom surface, an inner surface extending upwardly from an inner periphery of the bottom surface of the second lens, and an outer surface extending upwardly from an outer periphery of the bottom surface, a receiving space is defined by the inner surface of the second lens, the receiving space of the second lens receives the first lens therein, and the inner surface of the second lens is spaced from the top surface and the annular side surface of the first lens.
